(19) United States
(12) Patent Application Publication
(10) Pub. No.: US 2021/0221015 A1
(43) Pub. Date: Jul. 22, 2021

(54) Blade for Cutter Knife

(71) Applicant: OLFA CORPORATION, Osaka-shi, Osaka (JP)

(72) Inventor: Yosuke TAKASHIMA, Suita-shi, Osaka (JP)

(21) Appl. No.: 16/306,988

(22) PCT Filed: Jul. 13, 2018
(86) PCT No.: PCT/JP2018/026540

§ 371 Date: Dec. 4, 2018

(30) Foreign Application Priority Data
Aug. 29, 2017 (JP) 2017-163859

(51) Int. Cl. B26B 29/02

(52) U.S. Cl. CPC B26B 29/02

(57) ABSTRACT

There is provided a blade with high safety and ease, which is suitable for use with a cutter knife, as an item before step-up to an ordinary cutter knife used by an adult. In the blade of the present invention, almost all portion of a cutting edge which actually cuts an object is covered with a cover member, such that safety during handling the same is significantly high. Further, even when a blade body is made of metal, a cover member made from resin would reduce metal portion visible from outside, and thus reducing fear at a look.

### TECHNICAL FIELD

The present invention relates to a blade for a cutter knife, which is enhanced in safety and ease.

### BACKGROUND ART

A blade of a cutter knife is intended to cut an object, and thus many safety measures are taken for its handling. As a construction in which a cutting edge is partially covered with resin, there exists a cutter knife shown in Non-Patent Document 1 below. The cutter knife includes a blade that is covered with plastic such that only a tip of a cutting edge of the blade is exposed, thereby only the uppermost sheet of stacked many sheets could be cut while securing safety.

### PRIOR ART DOCUMENT

### Non-Patent Document

Non-Patent Document 1: OLFA Corporation, general catalog, 1998 edition, model 147 shown in page 9

### SUMMARY OF THE INVENTION

### Problems to be Solved by the Invention

It is an object of the present invention to provide a blade which is suitable for a cutter knife, as an item before step-up to an ordinary cutter knife used by an adult. Such the blade is primarily intended for use by children (or elderly people and women), and thus higher safety and ease are required.

### Solutions to the Problems and Effects of the Invention

The present invention provides a blade comprising “a blade body having a plurality of blade body breaking-lines at predetermined intervals, in a longitudinal direction of the blade body” and “a cover member fixed to the blade body to cover a cutting edge of the blade body from outside, except a region near a tip end of the blade body”.

The cover member includes cover member breaking-lines extending along the corresponding blade body breaking-lines to enable the blade body and the cover member to be broken simultaneously. Further, a cutout, partially exposing the cutting edge, is provided in an end portion of each of the cover member breaking-lines.

In the present invention, the “blade body breaking-line” and the “cover member breaking-line” mean a line, along which the blade body or the cover member can be broken (snapped) by hands. Each line is typically formed of a groove, but it is not limited to a particular construction, as long as the relative strength of the line is being reduced in some way to allow the breakage (snap) along the line.

Thanks to the blade of the present invention constructed as above, almost all portion of the cutting edge which actually cuts an object is covered with the cover member, such that safety during handling the same is significantly high. Further, even when the blade body is made of metal, a cover member made from resin would reduce metal portion visible from outside, and thus reducing fear at a look (or enhancing ease).

The cover member includes the cover member breaking-line extending “along” the blade body breaking-line, so that the blade body and the cover member can be broken simultaneously (by one action). Then the term “along” not only means a condition both the lines perfectly coincide without any deviation at all, but also means a condition there is some deviation between the lines, as long as the blade body and the cover member can be simultaneously broken by one action.

In the present invention, it is preferable that the blade further comprises a protective member, which is extending along the cutting edge exposed in the cutout, outwardly from the cutting edge.

With the blade constructed as above, there could almost eliminate inadvertent contact of an operator's fingertip or the like with the cutting edge exposed in the cutout, so that the safety and ease can be further enhanced.

In the present invention, it is preferable that the cover member further includes a tip cover member. This tip cover member (i) extends further beyond the tip end of the blade body; (ii) extends along the tip end of the blade body to outward from the cutting edge; and (iii) is connected to the cover member so as to be breakable along a cover member breaking-line.

With the blade constructed as above, the tip of the cutting edge of the blade, which been already exposed at the time of purchase by a user (in other words, the tip of the cutting edge of the blade, which have never been snapped), is blocked from the outside by the “tip cover member”. Thus, the safety and ease can be further enhanced.

In the present invention, it is preferable that the tip cover member further includes a protective member, which extends along the cutting edge, outwardly from the cutting edge. This enables the safety and ease to be further enhanced.

In the present invention, it is preferable that the tip end of the blade body extends perpendicularly to the cutting edge, and each of the blade body breaking-lines extends parallel to the tip end.

With the blade constructed as above, visual fear can be relatively lowered, compared to a case where the tip of the blade body is pointed having an acute angle. In this case, by making the blade body breaking-line also extend parallel to the tip end (that is, extend perpendicularly to the cutting edge), visual fear could be lowered also when the blade is snapped and a new cutting edge is coming.

While the blade of the present invention constructed as above can be used alone as a cutting tool, it can also be used as a replacement blade of a cutter knife, in which the blade can be slidably extended from or retracted into the cutter knife. In this case, the high safety and ease explained above would be significantly advantageous at replacing the blade.

### BRIEF DESCRIPTION OF THE DRAWINGS

FIG. 1A is a front view illustrating a blade according to a first embodiment of the present invention.

FIG. 1B is a front view of a blade body constituting the blade of FIG. 1.

FIG. 1C is a front view of a cover member constituting the blade of FIG. 1.

FIG. 2A is a perspective view of the blade illustrated in FIG. 1A.

FIG. 2B is another perspective view of the blade illustrated in FIG. 1A.

FIG. 3 is a perspective view illustrating an embodiment in which the blade of the present invention is used as a replacement blade of a cutter knife.

FIG. 4 is a front view illustrating a blade according to a second embodiment of the present invention.

FIG. 5 is a front view illustrating a blade according to a third embodiment of the present invention.

### EMBODIMENTS OF THE INVENTION

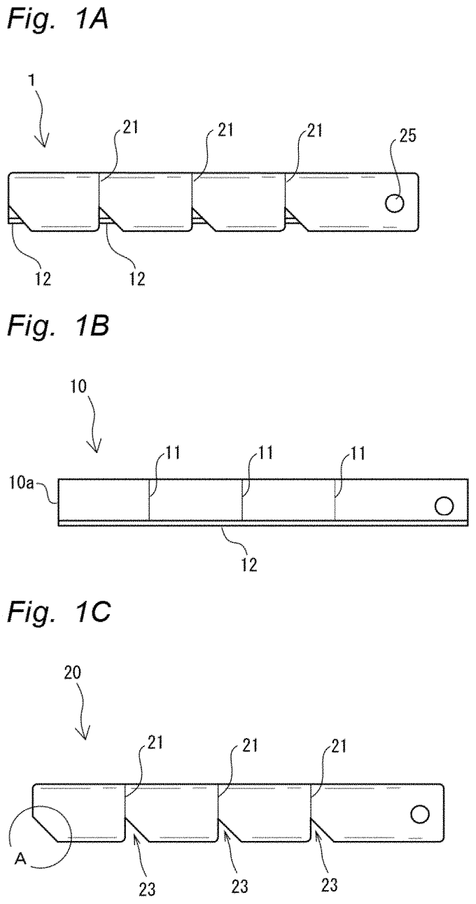

Embodiments of the present invention will be described below with reference to the accompanying drawings. FIG. 1A illustrates a blade 1 according to a first embodiment of the present invention. The blade 1 is constituted of a blade body 10 and a cover member 20. FIG. 1B illustrates the blade body 10 alone, and FIG. 1C illustrates the cover member 20 alone.

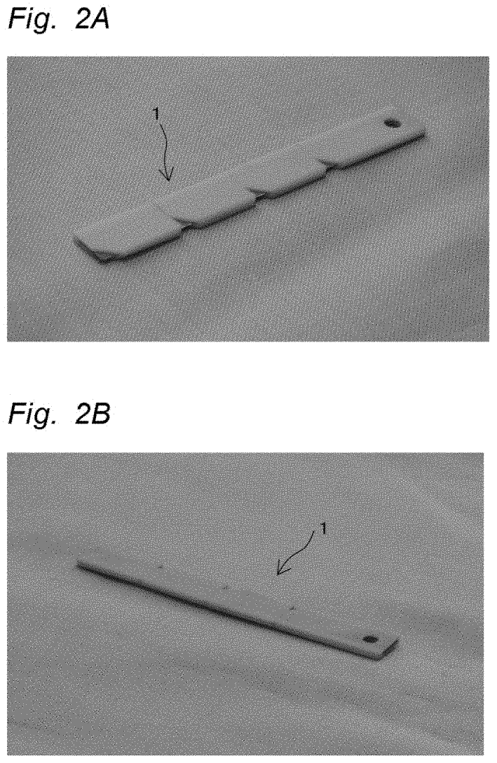

FIG. 2A is a perspective view illustrating the overall appearance of the blade 1, and FIG. 2B is a perspective view thereof viewed from another direction.

### <Blade Body 10>

The blade body 10 illustrated in FIG. 1B includes a cutting edge 12 on one side of the blade body 10 in the longitudinal direction, and a plurality of blade body breaking-lines 11 at predetermined intervals. This kind of construction itself is generally known. When sharpness is deteriorated, the blade body 10 is broken (snapped) along the blade body breaking-line 11 to enable a new edge tip to be used (sharpness of a new blade can be brought again).

### <Cover Member 20>

The cover member 20 illustrated in FIG. 1C is fixed to the blade body 10 to cover the cutting edge 12 from outside, thereby enhancing safety. However, the cutting edge 12 is exposed in a tip end region A that is necessary for actual cutting work.

As the cover member 20, a member of resign could be fixed to the blade body 10 by adhesion or the like, or could be fixed to the blade body 10 by integral molding, for example.

The cover member 20 includes cover member breaking-lines 21, that extend along the corresponding blade body breaking-lines 11 when the cover member 20 is fixed to the blade body 10. This enables the blade body 10 and the cover member 20, being integrated (that is, the entire blade 1), to be broken (divided) with one action, along one of the cover member breaking-lines 21.

The cover member 20 is provided, in an end portion of each of the cover member breaking-lines 21, with a cutout 23 for partially exposing the cutting edge 12. Thus, when the entire blade 1 is snapped, an edge tip of the blade body 10 is exposed, enabling cutting work.

The blade body breaking-line 11 and the cover member breaking-line 21 does not necessarily coincide (overlap) with each other completely, and there could be misalignment to some extent as long as the entire blade can be broken with one action. For example, positions of the blade body breaking-line 11 and the cover member breaking-line 21 may be slightly shifted from each other, such that a tip end of the blade body 10 is positioned inwardly away from an end face of the cover member 20 after being broken (snapped). This enables the tip end of the blade body 10 to be reliably prevented from protruding from the end face of the cover member 20 after the entire blade 1 is broken, so that high safety can be achieved.

In the illustrated embodiment, the whole of the blade body is covered with the cover member 20, except the region A and the cutouts 23, to achieve high safety and ease. However, covering at least the cutting edge 12 like in the illustrated embodiment would enable achieving relatively high safety and ease, although it may be inferior to the illustrated embodiment.

### <Effect of Basic Construction Above>

The blade 1 of the present invention has the basic construction as above, and thus the significantly high safety and ease can be achieved. That is, the cutting edge 12 of the blade body 10 has a minimized portion exposed to the outside, and thus enables minimizing risk that a user is injured or an unintended object is cut during cutting work or other handling.

In particular, in a region where the cutout 23 is formed in the cover member 20, the cutting edge 12 is exposed at a position inwardly away from a surface of the cover member. Thus, a user's finger could not touch the cutting edge 12 as long as the blade 1 is normally handled, thereby achieving high safety. This is significantly useful, for example, when the blade 1 is used as a replacement blade of a cutter knife, like in an embodiment illustrated in FIG. 3 described below.

Further, when the blade body 10 is made of metal, almost all of the metal blade body 10 is covered with the cover member 20 (that can be made of resin or the like). This enables reduction of a metal portion (particularly, the cutting edge) visible from outside, thereby reducing fear (enhancing ease).

<Construction in which the Tip End 10a of the Blade Body is Perpendicular to the Cutting Edge 12>

In a typical cutter knife, the tip end 10a (refer to FIG. 1B) of the blade body is often formed having an acute angle with respect to the cutting edge 12. However, in the present invention, it is preferable that the tip end 10a extends perpendicularly to the cutting edge 12. This can reduce visual fear, as compared to a case where the tip of the blade is pointed having an acute angle.

When such the construction is employed, it is preferable to also extend the blade body breaking-lines 11 parallel to the tip end 10a (that is, extend the blade body breaking-lines 11 perpendicularly to the cutting edge 12). This likewise enables visual fear to be reduced, also when the blade 1 is broken to come up with a new cutting edge.

### <Embodiment Wherein the Blade 1 is Used as a Replacement Blade of the Cutter Knife>

The blade 1 of the present invention described above has high safety when being handled directly by hand, so that the blade 1 alone can be used as a cutting tool. On the other hand, the blade 1 can also be used as a replacement blade of a cutter knife 30, in another practical use, which is illustrated in FIG. 3.

In the embodiment illustrated in FIG. 3, the cutter knife 30 includes a cutter knife body 31 formed of an elongated sleeve, and a slider 32 slidably mounted on the cutter knife body 31. The blade 1 of the present invention is attached to the cutter knife 30 as a replacement blade.

The blade 1 includes a through hole 25 as a connecting portion to the slider 32, and the slider 32 is provided with a protrusion (not illustrated) to be inserted into the through hole 25. Sliding the slider 32 with respect to the cutter knife body 31 would slide the blade 1 together with the slider 32, so that the blade 1 can be extended from or retracted into the cutter knife body 31.

The specific form of the cutter knife 30 is not limited to particular one, regarding the cutter knife body 31, the slider 32, and others.

### Second Embodiment

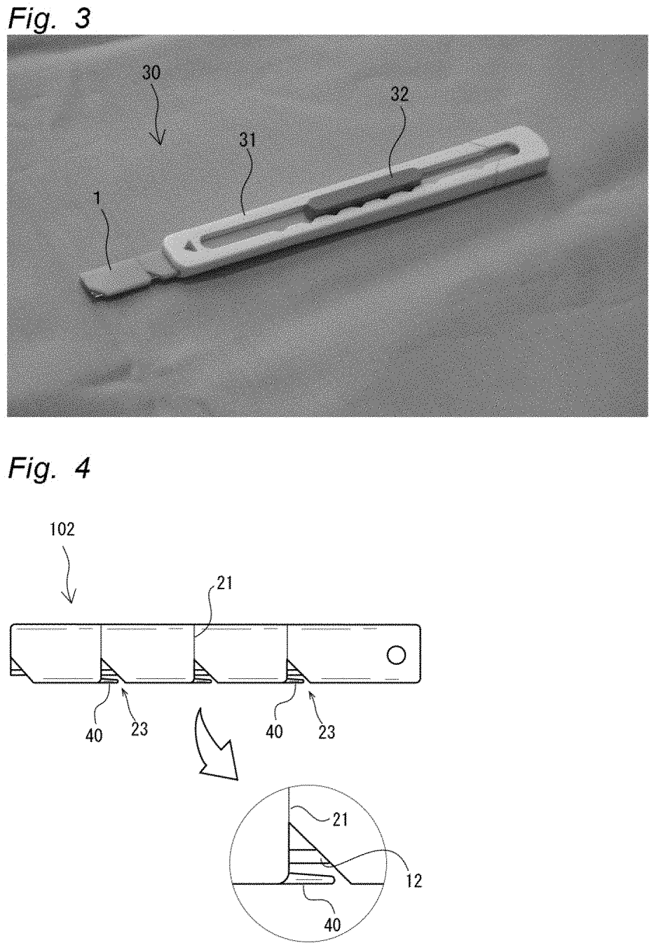

FIG. 4 illustrates a blade 102 according to a second embodiment of the present invention. The blade 102 of the second embodiment is different from the first embodiment in that a protective member 40 of a rod shape is provided in the cutout 23. Thus, only the different features will be described.

As illustrated partially in an enlarged manner in FIG. 4, the protective member 40 of a rod shape is erected on one wall portion of the cutout 23. The protective member 40 extends along the cutting edge 12 exposed in the cutout 23, outwardly from the cutting edge 12.

Employing such the construction can almost eliminate inadvertent contact of an operator's fingertip or the like with the cutting edge 12 exposed in the cutout 23, so that the safety can be further enhanced. Also from a view point of visual impression, since the cutting edge 12 is covered with the protective member 40, the ease also can be further enhanced.

The specific shape and position of the protective member 40 is not limited to what illustrated in the drawings, and could be changed conveniently. For example, while the protective member 40 is erected from a left side wall in the illustrated embodiment, the protective member 40 may be erected from a right side wall. Further, while a gap is provided between the protective member 40 and the cutting edge 12 in the illustrated embodiment, the gap may be eliminated.

### Third Embodiment

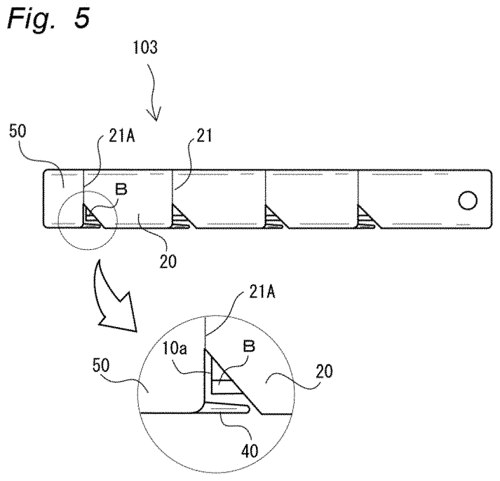

FIG. 5 illustrates a blade 103 according to a third embodiment of the present invention. The blade 103 of the third embodiment is different from the second embodiment in that a tip cover member 50 is provided at a tip end of the cover member 20. Thus, only the different features will be described.

As illustrated in FIG. 5, the tip cover member 50 firstly extends (i) further beyond the tip end 10a (refer to FIG. 1B) of a blade body (leftward in FIG. 5).

The tip cover member 50 also extends (ii) along the tip end 10a of the blade body to outward from the cutting edge 12. While a gap is provided between the tip cover member 50 and the tip end 10a in the embodiment of FIG. 5, the gap may be eliminated.

As is clearly understood by comparing FIG. 4 with FIG. 5, the cutting edge B of the blade 103 of the third embodiment is covered with the tip cover member 50, even when a user has never broken the blade after purchase of the blade (that is, the blade 103 is brand-new). This achieves higher safety and ease, than the blade 102 of the second embodiment (or the first embodiment).

The tip cover member 50 is (iii) connected to the cover member 20 so as to be breakable along the cover member breaking-line 21A. Thus, when the blade 103 is used for the first time, an operator can easily snap off the tip cover member 50 by pinching the tip cover member 50 with the fingers.

The cover member breaking-line 21A can have same construction as the other cover member breaking-lines 21 described above, and a specific construction thereof is not limited to particular one, as long as the tip cover member 50 can be easily snapped off, along the cover member breaking-line 21A.

As illustrated in FIG. 5, it is preferable to provide a protective member 40 also on the tip cover member 50. This protective member 40, like what is provided in the cutout 23 in the second embodiment, also prevents a finger of an operator from inadvertently touching the cutting edge, thereby enhancing the safety and ease.

The blades 102, 103 according to the second or the third embodiment, like the blade 1 of the first embodiment, also can be used alone as a cutting tool, or used as a replacement blade of the cutter knife 30 (refer to FIG. 3).

### DESCRIPTION OF REFERENCE SIGNS

1, 102, 103: Blade
10: Blade body
11: Blade body breaking-line
12: Cutting edge
20: Cover member
21: Cover member breaking-line
23: Cutout
25: Through hole
30: Cutter knife
31: Cutter knife body
32: Slider
40: Protective member
50: Tip cover member

1-6. (canceled)

7. A blade comprising:
a blade body having a plurality of blade body breaking-lines at predetermined intervals, in a longitudinal direction of the blade body; and
a cover member fixed to the blade body to cover a cutting edge of the blade body from outside, except a region near a tip end of the blade body, wherein
the cover member includes cover member breaking-lines extending along the corresponding blade body breaking-lines to enable the blade body and the cover member to be broken simultaneously, and
a cutout, partially exposing the cutting edge, is provided in an end portion of each of the cover member breaking-lines.

8. The blade according to claim 7, further comprising a protective member which is extending along the cutting edge exposed in the cutout, outwardly from the cutting edge.

9. The blade according to claim 7, wherein the cover member further includes a tip cover member, and
the tip cover member
(i) extends further beyond the tip end of the blade body;
(ii) extends along the tip end of the blade body to outward from the cutting edge; and
(iii) is connected to the cover member so as to be breakable along a cover member breaking-line.

10. The blade according to claim 9, wherein the tip cover member further includes a protective member which extends along the cutting edge, outwardly from the cutting edge.

11. The blade according to claim 7, wherein
the tip end of the blade body extends perpendicularly to the cutting edge, and
each of the blade body breaking-lines extends parallel to the tip end.

12. The blade according to claim 8, wherein
the tip end of the blade body extends perpendicularly to the cutting edge, and
each of the blade body breaking-lines extends parallel to the tip end.

13. The blade according to claim 9, wherein
the tip end of the blade body extends perpendicularly to the cutting edge, and
each of the blade body breaking-lines extends parallel to the tip end.

14. The blade according to claim 10, wherein
the tip end of the blade body extends perpendicularly to the cutting edge, and
each of the blade body breaking-lines extends parallel to the tip end.

15. A cutter knife comprising:
a cutter knife body;
a slider slidable with respect to the cutter knife body; and
the blade according to claim 7, being connected to the slider to be extended from or retracted into the cutter knife body in accordance with sliding operation of the slider.

16. The cutter knife according to claim 15, further comprising a protective member which is extending along the cutting edge exposed in the cutout, outwardly from the cutting edge.

17. The cutter knife according to claim 15, wherein the cover member further includes a tip cover member, and
the tip cover member
(i) extends further beyond the tip end of the blade body;
(ii) extends along the tip end of the blade body to outward from the cutting edge; and
(iii) is connected to the cover member so as to be breakable along a cover member breaking-line.

18. The cutter knife according to claim 17, wherein the tip cover member further includes a protective member which extends along the cutting edge, outwardly from the cutting edge.

19. The cutter knife according to claim 15, wherein
the tip end of the blade body extends perpendicularly to the cutting edge, and
each of the blade body breaking-lines extends parallel to the tip end.
